(19) United States
(12) Patent Application Publication
(10) Pub. No.: US 2021/0124045 A1
(43) Pub. Date: Apr. 29, 2021

(54) SMART WEARABLE SENSOR SYSTEM AND METHODS TO LOWER RISKS OF DISTRACTED WALKING

(71) Applicant: Shijun Xiao, Foster City, CA (US)

(72) Inventor: Shijun Xiao, Foster City, CA (US)

(21) Appl. No.: 16/714,752

(22) Filed: Dec. 15, 2019

Related U.S. Application Data
(60) Provisional application No. 62/926,567, filed on Oct. 28, 2019.

(51) Int. Cl. G01S 15/93; G06F 1/16; H04M 1/02; A44C 5/00; G04G 99/00

(52) U.S. Cl. CPC G01S 15/93; G06F 1/163; G01S 17/93; A44C 5/0007; G04G 99/006; H04M 1/0202

(57) ABSTRACT

Smart wearable sensor system and methods to lower risks of distracted walking, and the system includes at least a smart mobile device connected to both the wearables and a machine learning block. The wearables is used to sense users' environment and acquire featured data. The smart mobile device computes on the featured data with existing algorithms and models and makes judgement to alert users of objects and situations needing attention. In the machine learning block, servers are used to construct machine learning algorithms and models, and a computing block is used to train the algorithms and models. The servers update algorithms and models regularly. The servers are connected to the mobile device thru a wireless network, and the mobile device downloads updated algorithms and models from the servers. The system is intelligent as the algorithms and models are continuously optimized and improved. The intelligence helps the person to percept the surroundings and effectively lower the risk of accident as a result of dropped vision and hearing during distracted walking.

### FIELD OF THE INVENTION

The present invention relates generally to wearables, sensors, and internet of things. More particularly, the invention is directed toward smart wearable sensor system and methods to lower risks of distracted walking with a smart mobile device.

### BACKGROUND OF THE INVENTION

With the popularity of smartphones, pads, smartwatches, pedestrian watching these smart mobile devices is commonly seen as people use them for navigation, games, social media apps, news, etc. When one is focused on something as small as a phone, a pad, and a watch, the peripheral vision could drop to 10% of what it would normally be, and other perception like hearing sense also drop significantly. This is termed as distracted walking, as shown in FIG. 1. Not only they risk walking near moving vehicles, they also risk of tripping and falling over curbs or debris, stepping in a pothole or crack, suffering a concussion from hitting a sign or lamp post head, and colliding with another distracted pedestrian. These people are more vulnerable when walking in urban areas, crossing busy streets. The safety with this large group of people distracted by smart mobile devices is becoming more serious as the mobile user's number increases. Each year, more and more people are injured as a result of distracted walking.

It seems not very practical to make traffic rules to forbid distracted walking. Distracted walking is on individual own risk. Safety of distracted walking with smart mobile devices becomes an important public problem to solve. There are still lack of effective techniques invented to lower risks of distracted walking.

### SUMMARY OF THE INVENTION

To solve the aforementioned safety issues with distracted walking, the invention is to propose the idea of smart wearable sensor system and methods to lower risks of distracted walking by detecting and reporting objects or situations that need users' immediate attention. With wearable sensors, users are able to percept their surroundings while they are distracted during walking. The system can alert users of these risks around their walking environment, thus to lower risks of accidents. The system is intelligent as it continuously improved and optimized with techniques of artificial intelligence and machine learning.

The technology used in this invention is summarized here. A smart wearable sensor system to lower risks of distracted walking includes at least a smart mobile device connected to both wearable sensors and a machine learning block. The wearable sensors are used to sense users' surroundings and acquire featured data. The smart mobile device computes on the featured data with existing algorithms and models and makes judgement to alert users of objects around and scenarios that are likely cause an accident. In the machine learning block, servers are used to construct machine learning algorithms and models, and a computing block is used to train the algorithms and models. The servers update algorithms and models regularly. The servers are connected to the mobile device thru a wireless network, and the mobile device downloads updated algorithms and models from the servers.

The wearables contain one or multiple sensors, and its package's shape is a box. There is a magnetic clip on the back side of the box. The clip can be either flat or curved. There is a ring fixed on the top of the box. The sensors include vision sensor, audio sensor, ultrasonic sensor, infrared laser sensor (LIDAR: light detection and ranging), and RADAR (radio detection and ranging). The way to wear these sensors includes smart hat, smart clothes, smart bracelet, smart glass, and smart headset. The smart hat is configured with a solar cell to power the sensors. The smart mobile device includes phone, pad, or watch. There are apps installed on the smart mobile device. The apps are used to connect the device to both the sensors and machine learning servers, and to transmit data. The mobile device uploads the data to the machine learning block for storage as well as continuous optimization on algorithms and models.

The invention utilizes machine learning algorithms and models to compute on the data and make decisions on potential danger in surroundings to the distracted walking people. The system is intelligent as the algorithms and models are continuously optimized and improved. The intelligence helps the person to percept the surroundings and effectively lower the risk of accident as a result of dropped vision and hearing. The smart mobile device uses apps to notify users of potential danger in time, thru wearable sensors, detecting moving vehicles, curbs, potholes, obstacles, which pose danger to pedestrian. The notification can be in all possible ways to have the user's attention as soon as possible.

Computing resource is used to train and optimize the machine learning algorithms and models, so that the prediction error is continuously minimized. With the continuous learning, the system is continuously developed. The machine learning is based on cloud service model and serves multiple users at the same time. The wearable device is easily worn on the body, and it is cost effective, and it is easily connected and operated with a smart mobile device. The wearable device can be easily attached to the hat or the clothes without affecting their function.

### BRIEF DESCRIPTION OF THE FIGURES

The invention is more fully appreciated in connection with the following detailed description taken in conjunction with the accompanying drawings, in which:

FIG. 1 illustrates distracted walking with a smart mobile device.

FIG. 2 illustrates the system architecture in accordance with an embodiment of the invention.

FIG. 3 illustrates the working principle in accordance with an embodiment of the invention.

FIG. 4 shows examples of wearables in accordance with an embodiment of the invention.

FIG. 5 illustrates the smart hat used in FIG. 4.

FIG. 6 illustrates the wearable device used in FIG. 4.

FIG. 7 illustrates another wearable device used in FIG. 4.

FIG. 8 illustrates one another wearable device used in FIG. 4.

FIG. 9 shows examples of notification accordance with an embodiment of the invention.

FIG. 10 illustrates the neural network model used in FIG. 9.

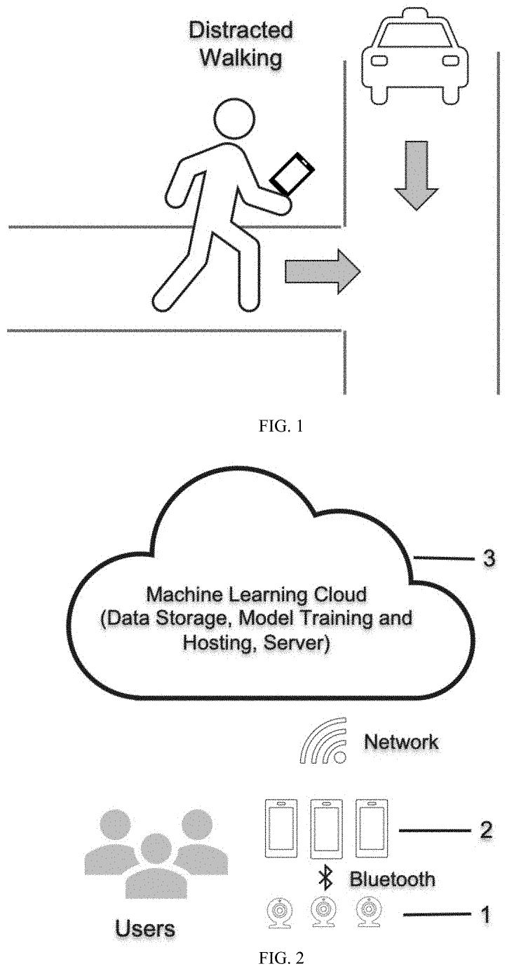

Like reference numerals refer to corresponding parts throughout the several views of the drawings. 1: Wearables. 2: Smart Mobile Device (Phone, Pad, Watch). 3: Machine Learning Block. 4: Sensor. 5: Server. 6: Computing Resource. 7: Storage. 8: Solar Cell. 9: Smart Hat. 10: Smart Clothes. 11: Smart Bracelet. 12: Smart Glass. 13: Smart Headset. 14: Sensor Package. 15: Magnetic Clip. 16: Transparent Tape.

### DETAILED DESCRIPTION OF THE INVENTION

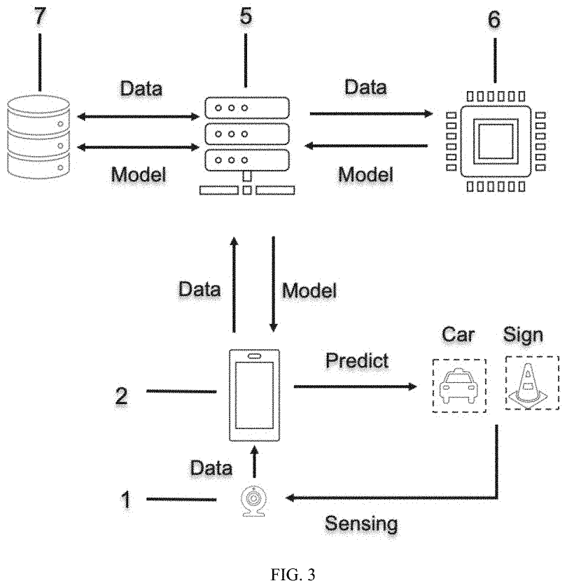

FIG. 2-3 illustrates the overall system architecture and the working principle. The system consists of wearables 1, smart mobile device (phone, pad, and watch) 2, and machine learning block 3. The wearables 1 is wearable and contains one or multiple sensors 4 to percept the environment. The smart mobile device 2 is communicated with the wearables 1 thru wireless communication. The smart mobile device 2 acquires the data thru the wearables 1 about the user's surrounding. The smart mobile device 2 uses already stored machine learning algorithms and models to analyze the data, and it notifies users of potential dangers in the surroundings or objects to be paid attention to. The machine learning block 3 consists of the server 5 to build and serve machine learning algorithms and models, the computing block 6 to train algorithms and models. The server 5 updates algorithms and models regularly, and the server 5 communicates with the smart mobile device 2 thru wireless network. The smart mobile device 2 downloads new version of algorithms and models from the server 5, and the smart mobile device 2 upgrades older version model to the new version model. The machine learning block 3 also contains a storage block 7, where both data and models are stored. The machine learning block 3 is a cloud service.

The wearables 1 includes an object can be worn on the body, and attached to the object with one or multiple sensors 4, e.g., imaging sensor, ultrasonic sensor, mic sensor, infrared laser sensor (LIDAR: light detection and ranging), and RADAR (radio detection and ranging). The data collected includes imaging, video, audio, and reflection. The wearables 1 is connected to the mobile device 2 thru wireless transmission, e.g., WiFi, Bluetooth, or other wireless communication technologies. The wearables 1 intelligently senses the surroundings around user, acquires featured data, and transmits these data to the smart mobile device 2.

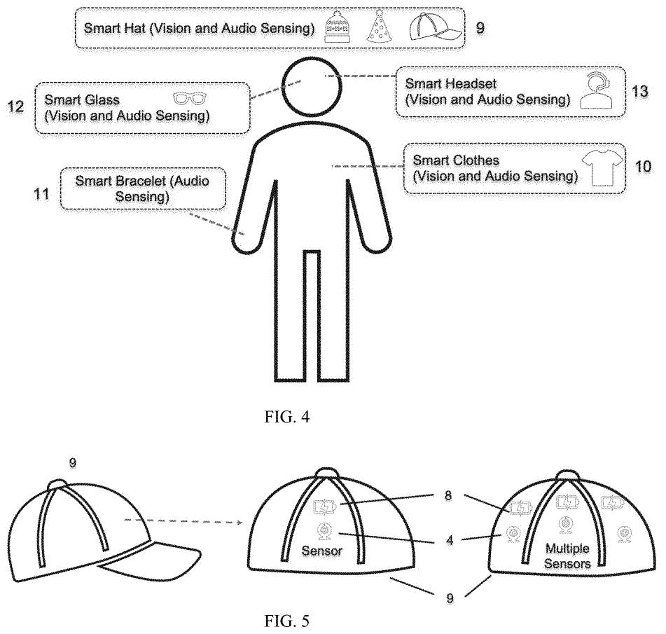

The wearable ways are shown in FIG. 4. The wearables 1 can be attached to any part of an user's apparels, and it can be but not limited to a smart hat 9, smart clothes 10, a smart bracelet 11, a smart glass 12, and a smart headset 13. Both imaging sensors and audio sensors can be integrated into the smart hat 9, the smart clothes 10, the smart glass 12, and the smart headset 13, and audio sensors can also be integrated into the smart bracelet 11. On the smart hat 9, multiple vision sensors can be mounted at different locations for different directions, capturing imaging or video data from multiple view angles. The smart hat 9 may also have a solar cell 8 to power the sensor 4 (FIG. 5). When the sensor 4 is attached to an user's apparels thru a pluggable way, the sensor 4 can be packed into a single sensor package 14. The package 14 can also be taken away from the apparels and attached to the smart mobile device 2.

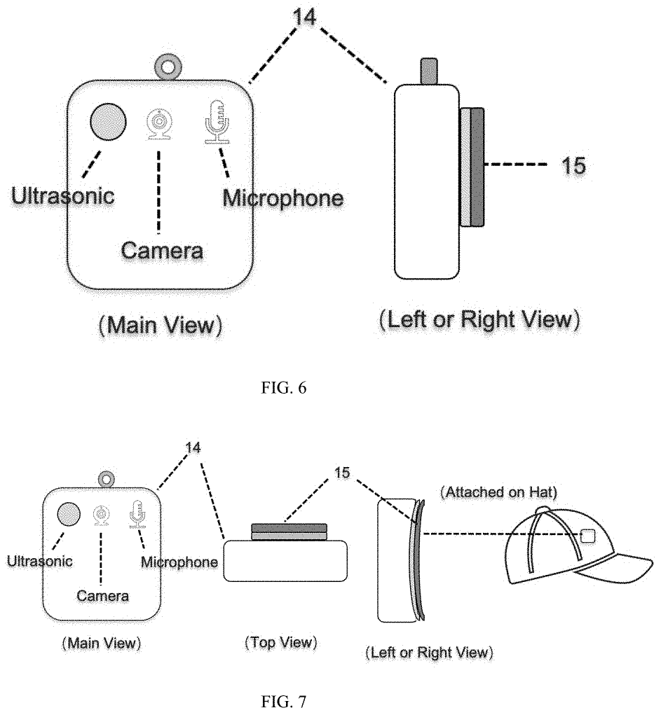

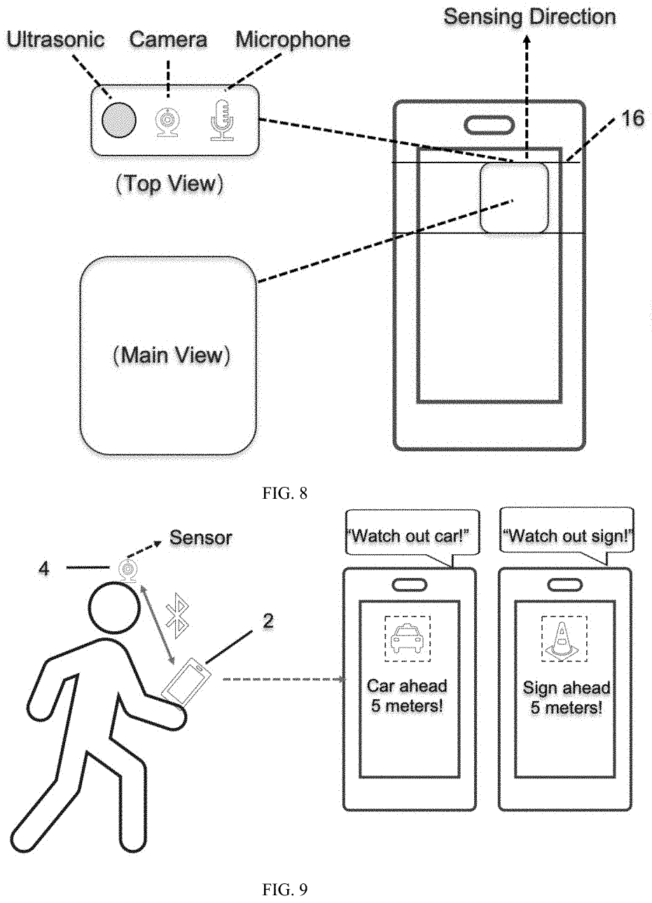

As it is illustrated in FIG. 6, the sensor package 14 is in a box shape, and it contains ultrasonic sensor, imaging sensor (camera), and sound sensor (mic). The sensor's sensing direction is in the forward direction of the package 14. On the back of sensor package 14, there are magnetic clips 15. The sensor package can be worn on the clothes to form smart clothes 10. On the top of the sensor package 14, there is a ring to be used with a necklace for hanging around the user's neck. As it is illustrated in FIG. 7, the back of the sensor package 14 can be a curved surface, and the magnetic clip 15 is also curved, and the package 14 can be attached on to a hat thru the magnetic clip 15 to form a smart hat 9. As it is illustrated in FIG. 8, the sensor package 14 has a transparent tape 16 on both sides, and the tape 16 is used to circle around the smart mobile device so that the sensor package 14 is attached to the mobile device without affects the mobile device's function, where the sensor's sensing direction is from the top to outward.

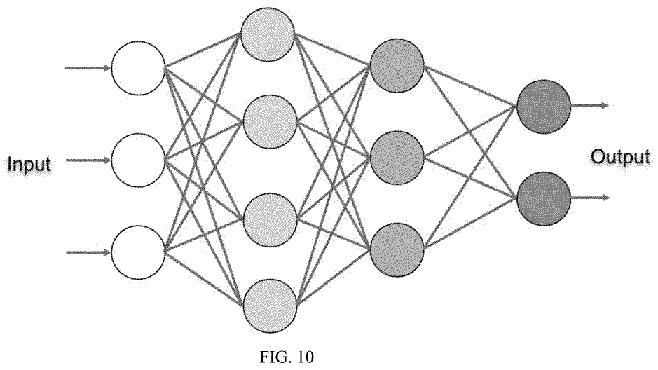

The smart mobile device 2 includes smartphone, pad, and smartwatch, etc., which can cause distracted walking. Apps installed in the smart mobile device 2 are used to communicate with both the wearables 1 and the machine learning block 3. The smart mobile device 2 can transmit sensing data to the machine learning block 3 for model training, and it can also download new models and update exiting models. The apps use machine learning algorithms and models to analyze the data captured by sensors. If the result meets the requirement or condition that need attention from pedestrian, the smart mobile device 2 will issue an alert to the user about detected objects or scenarios, e.g., vehicle nearby, speed, direction, and distance, etc. The way to notify includes but is not limited to display picture and text on the screen, make a speech, and make vibration, etc. (FIG. 9). If the result doesn't meet the condition, there is no alert, and the smart wearable sensor system will be ready for checking next round. Since the user walks at a slow speed, the wearable sensor system may respond within 1 second when it detects user in distracted walking for a preconfigured duration.

For the machine learning block 3, the server 5 is responsible for building machine learning algorithms and models. The server 5 writes the raw data from the mobile device 2 to the storage block 7, and the data can be read from the storage anytime by the server 5. The data can be labeled and processed for supervised machine learning. Then, the data is engineered to the format for machine learning and sent to the computing block 6. The computing block 6 has powerful computing resource including graphical processing unit (GPU). The computing block 6 is used to train and optimize machine learning algorithms and models such as artificial neural network. Then, these algorithms and models are saved in files that are stored in the storage block 7. The smart mobile device 2 can regularly download these files or the system can remind of users.

The machine learning algorithms and models include but are not limited to support vector machine (SVM), decision tree, and artificial neural network, etc. The invention uses artificial neural network for illustration. The artificial neural network simulates human's brain neural network. As it is illustrated in FIG. 10, the artificial neural network has multiple inputs and one or multiple outputs, and the network is formed through many interconnected nodes. The network has layered structure in order, which has input layer, hidden layers, and output layer. The hidden layer can be just one or multiple. The more the hidden layers, the better the performance is generally, and this is termed as deep learning. Mathematical representation of the artificial neural network is normally saved in files, and it contains parameters of layer number, node number in each layer, the activation function at each node, and the weight between two connected nodes, etc. To classify multiple objects, a relatively big model with multiple outputs can be used, or we may use different models for different objects with relatively small model.

The working process of artificial neural network is described here. The input signal is an array of feature variables' numerical values engineered from the acquired imaging or audio data. The signal is linearly added with weights as the input to the corresponding node in next layer, and a nonlinear activation function of that node is used to compute the output of this node. This calculation process passes all hidden layers and the final output layer, and it is called forward propagation in neural net. The final output is a probability between 0 and 100%, e.g., the chance of recognizing an object analyzed from the data. The neural network model is used to check the possibility of a targeted object in the imaging or audio data. If the probability is over the threshold, a response can be triggered. Users use the smart mobile device 2 to download model files from the machine learning block 3, and the apps use the model to compute on the feature data about the surrounding. For example, the wearables 1 captures 4 images ahead with focus at 5, 10, 15, and 20 meters, respectively, and the calculated probability of a vehicle in the images is 80%, 95%, 80%, and 70%, respectively. If the probability threshold is set at 90%, the intelligence can draw a conclusion that there is a vehicle near 10 meters ahead. The focus step may be smaller for better accuracy of the vehicle location, e.g., in 2 meters, if the imaging sensor's focus sensitivity allows. The wearables 1 can also use ultrasonic wave for further object ranging and sensing, e.g., how far a vehicle ahead is and its speed on the sensing direction. To detecting moving vehicles, the wearables 1 captures a series of images from video at an optimized frame rate. When the identified vehicle is not outside the safe distance, the smart mobile device 2 sends user an alert, e.g., a vehicle about 10 meters ahead crossing from left to right with a speed 20 miles/hour.

The computing resource 6 is used to train algorithms and models, e.g., to continuously optimize neural network so that the predication accuracy is improved all the time and recognized objects get more and more. The optimization of neural network requires complex matrix computation and graphical processing units to carry out the tasks. Labeled training data is needed. The optimization is called backward propagation for neural network. The optimization is to find the solution of all weight parameters that yield the minimum prediction error over the training data. The neural network is trained with labeled data, and this is called supervised machine learning.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. Smart wearable sensor system and methods to lower risks of distracted walking, and the system comprising: a wearables to percept user's surroundings to generate data; a smart mobile device to communicate with the wearables and collects data from the wearables, and the mobile device use exiting algorithms and models to compute on the data to make judgement of objects and situations that need the user's attention; a machine learning cloud consists of servers and computing resources. The machine learning block consists of servers to build and serve machine learning algorithms and models, a computing block to train algorithms and models. The servers update algorithms and models regularly, and the servers communicate with the smart mobile device thru wireless network. The smart mobile device downloads new version of algorithms and models from the servers, and the smart mobile device upgrades older version model to the new version model.

2. The smart wearable sensor system wherein in claim 1 the wearables is a wearable object worn on the body and one or multiple sensors installed in the object.

3. The smart wearable sensor system wherein in claim 2 the sensors installed on the wearable object are packed in a single housing, and the shape of the housing is a box, and the back of the housing has magnetic clips.

4. The smart wearable sensor system wherein in claim 3 there is a ring on the top of the housing, or the back surface of the housing is concave.

5. The smart wearable sensor system wherein in claim 2 the sensors installed on the wearable object are packed in a single housing, and there are elastic transparent tapes on both the left side and the right side, and the tape is used to attach the housing to the mobile device by circling around it.

6. The smart wearable sensor system wherein in claim 2 the sensors include one or more from vision sensor, ultrasonic sensor, audio sensor, LIDAR, and RADAR.

7. The smart wearable sensor system wherein in claim 1 the wearables can be smart hat, smart clothes, smart bracelet, smart glass, and smart headset or the combination of these.

8. The smart wearable sensor system wherein in claim 7 the smart hat can have solar cell to power the installed sensors.

9. The smart wearable sensor system of claim 1 the smart mobile device is smartphone, pad, and smartwatch.

10. The smart wearable sensor system of claim 1 the smart mobile device uses installed apps to connect with the wearables and the machine learning block for data communication. After receiving the data about the surroundings, the smart mobile device computes on the data with existing algorithms and models. The smart mobile device sends raw data to the machine learning block for data storage.
